(19) United States
(12) Patent Application Publication
(10) Pub. No.: US 2012/0079037 A1
(43) Pub. Date: Mar. 29, 2012

(54) SYSTEMS AND METHODS FOR NON-VOICE MOBILE APPLICATIONS

(76) Inventors: Rahuldev Rajguru, Rajkot (IN); K. Ganapathy Subramanian, Bangalore (IN)

(21) Appl. No.: 12/893,560

(22) Filed: Sep. 29, 2010

(51) Int. Cl. G06F 15/16

(52) U.S. Cl. 709/206

(57) ABSTRACT

A method of processing a text message at a platform server includes processing the text message to obtain a first text element and a second text element, and communicating information associated with one or both of the first text element and the second text element to the sender of the text message or a third party, through a communication network. The platform server is administered by one or both of an administrator and a user with or without an account associated with the platform server. The text message includes the first text element and the second text element, linked by a visible non-alphanumeric character.

### BACKGROUND

1. Technical Field

The present invention is directed generally to applications for mobile devices and more particularly to systems and methods for processing text messages.

2. Background

In addition to functioning as portable voice machines, mobile devices have significant data communication capabilities. Communication technologies (e.g., data channels, voice channels and signaling channels) as well as applications may be preconfigured and/or downloaded to mobile devices in order to enable non-voice applications. Non-voice applications (e.g., sending short messages, multimedia messages, picture messages, e-mails, video files, audio files) utilize communication networks including the proprietary networks of service providers (e.g. mobile operators) as well as public internet infrastructures to transmit information between mobile devices and other devices.

In a communication network, data may be transferred from a single mobile device to another single device or to multiple devices within the same network, or in a different network. In the realm of voice communications, there are many service providers who integrate the powers of web services, mobile devices, and communication networks in order to seamlessly transfer data. Such integration, is however, lacking in the realm of non-voice services for a variety of reasons (e.g. commercial limitations, lack of expertise, intra network/walled garden approach, conflicts of interest, license restrictions). As a result, service providers are constrained in their ability to provide a wide range of convenient applications for consumers.

Particularly, the non-voice services available to consumers are limited to a set of services that do not include a wide range of intra-network services. Moreover, unlike a computer, the mobile device is a small device with a limited screen size and poses significant barriers to end user adoption of non-voice services. The key drivers for the adoption of non-voice services include, however, such factors as convenience, education, simplicity and ease of use. For example while almost every mobile user uses voice services, it is estimated that about only 50% use person to person SMS services and less than 5% uses other value added services such as GPRS-based services. Nonetheless, it is also estimated that the reach of mobile phone is over 4-6 times the reach of Internet access in developing countries. Consequently, there is an unfulfilled need for convenient and user-friendly non-voice applications for mobile devices.

### SUMMARY

In view of the foregoing, an embodiment of the invention provides a method of processing a received text message at a platform server. The method includes processing the text message to obtain a first text element and a second text element, and communicating, through a communication network, information associated with at least one of the first text element and the second text element to the sender of the text message or a third party.

According to some embodiments, the text message may be sent to the platform server via a target number. The platform server may be administered by one or both of an administrator and a user with or without an account associated with the platform server. The text message may include the first text element and the second text element, linked by a visible non-alphanumeric character. The first text element may be associated with a user of the platform server, and the second text element may be pre-defined by at least one of a user or an administrator of the platform server.

In many embodiments, the non-alphanumeric character may be a dot, a hash, or an asterisk. Further, a mobile number associated with the sender of the text message may be obtained. The second text element may correspond to a group of contacts, and the first text element may correspond to an identifier of the group of contacts. The third party may be associated with the group of contacts. In many embodiments, the network may be a mobile network, and the text message may further include an additional parameter associated with contact information or information associated with a message. The second text element may correspond to an extension that represents a file, the first text element may correspond to a file name, and the target number may be a short code number.

Another embodiment of the invention provides a system that includes a memory for storing information associated with a text message, and a processor for processing a text message sent by a sender to a target number. The system may be administered by one or both of an administrator and a user, where the user has an account associated with the system. The text message may include a first text element and a second text element linked by a visible non-alphanumeric character. The processor is configured to process the text message to obtain the first text element and the second text element; match the first text element with a list of categories configured by at least one of the user, the sender, or the administrator; obtain a matching category from a list of categories if the matching category corresponds to the first text element; match the second text element with a list of sub categories in the account of the user associated with the matching category if the matching category corresponds to the first text element; and perform an action based on at least one of the first text element and the second text element. The text message may additionally include a parameter.

According to various embodiments, the action based on at least one of the first and second text elements may include communicating the parameter to one or more contacts associated with the first text element, if the first text element corresponds to a predefined category defined by the administrator in the list of categories. The parameter may be an email address. In addition, the action may include communicating a file associated with the account of the user and/or sender of the text message to the email address.

The approach utilized by the various embodiments presented herein results in greater efficiency and usability, when compared to single keyword approaches currently used for non-voice mobile device applications. For example, existing single keyword applications require users to send a text message with a particular keyword to trigger a particular action. Such applications not only require the user to memorize a large number of keywords in order to perform a variety of tasks, but also require the system to maintain and search through large repositories of such keywords. The approach of using a hierarchical, multi-element format instead of a single keyword format reduces the burden on both mobile application users and the system. Particularly, in the approach utilized by the embodiments of the invention, participants and actions may be previously categorized into groups, and these groups may be traversed hierarchically, based on a parsing of the sender's text message. For example, a text message with the hierarchical expression “payment.mobile” may directly lead the backend system to search within a chosen category (payment), and consequently result in the system having to perform a search of a relatively small number of sub-categories associated with the payment category.

Moreover, approaches currently utilized in the area of non-voice mobile applications lack flexibility. For example, if the keyword ‘123’ is defined to effect sending a text message to all members of a previously specified group, a separate and possibly unrelated keyword must be defined to effect sending the same text message to a subset of the same group. Such approaches once again unnecessarily burden both the user's memory and server resources. By contrast, the approach utilized in the embodiments described herein is well suited to alleviate such burdens. An administrator and/or user may predefine related categories that are both easy to remember and impose a far lesser search burden on the system. For example, the expression “companyA.employees” may be used to have a message sent to all employees of company A, while the expression “companyA.managers” and “companyA.technicians” may be used to have the same message sent to the managers and technicians of companyA respectively.

These and other embodiments described herein will be better appreciated and understood when considered in conjunction with the following description and the accompanying drawings. It should be understood, however, that the following descriptions, while indicating various embodiments and numerous specific details thereof, are given by way of illustration and are not intended to be limiting. Many changes and modifications may be made to the embodiments herein without departing from the spirit and scope of the invention.

### BRIEF DESCRIPTION OF THE DRAWINGS

The embodiments herein will be better understood from the following detailed description with reference to the drawings, in which:

FIG. 1 illustrates a system view of a mobile device communicating with a platform server through a network, according to some embodiments of the invention;

FIG. 2 illustrates an exploded view of the platform server of FIG. 1, according to some embodiments of the invention;

FIG. 3 is an user interface view of the configuration module of the platform server of FIG. 1, according to some embodiments of the invention;

FIG. 4 is a depiction of a category configuration user interface of the configuration module of the platform server of FIG. 1, according to some embodiments of the invention;

FIG. 5A and FIG. 5B provide user interface views of the mobile device of FIG. 1 communicating a text message to a group and an individual user, according to some embodiments of the invention;

FIG. 6 illustrates a table view of a user database of the platform server of FIG. 1, according to some embodiments of the invention;

FIG. 7 is a flow diagram illustrating a method of processing a text message sent to the platform server of FIG. 1, according to some embodiments of the invention;

FIG.8 is a flow diagram illustrating a method of processing a text message to obtain a first text element and a second text element, according to some embodiments of the invention; and

FIG. 9 illustrates a schematic diagram of a computer architecture involved in some embodiments of the invention.

### DETAILED DESCRIPTION OF PREFERRED EMBODIMENTS

Features and details of the various embodiments of the invention described below are explained more fully with reference to the non-limiting illustrations in the accompanying drawings. Descriptions of well-known components and processing techniques are omitted so as to avoid unnecessarily obscuring the embodiments themselves. The examples presented herein are intended merely to facilitate an understanding of the various ways in which the invention may be practiced. The examples should accordingly not be construed as limiting the scope of the invention.

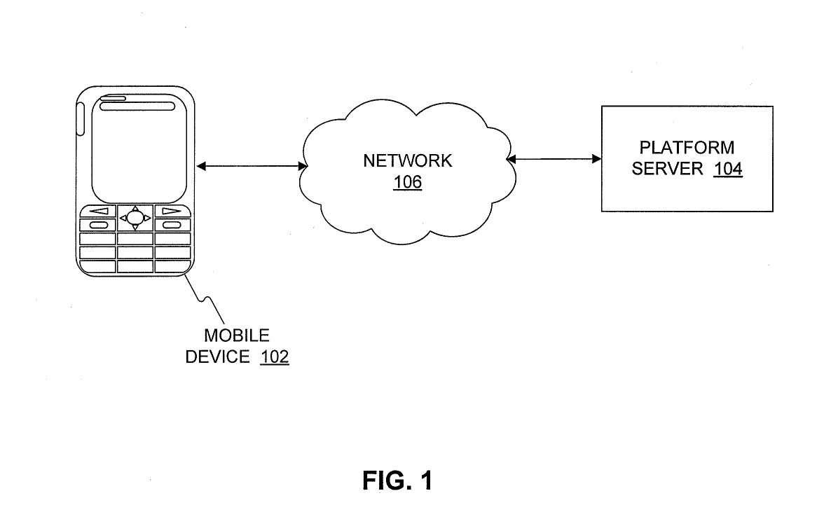

There remains a need for an efficient and useable approach to enhance non-voice data transfer in communication networks. Toward that end, some embodiments described herein provide methods of processing a received text message at a platform server. The methods include processing the text message to obtain a first text element and a second text element, and communicating information associated with at least one of the first text element and the second text element to the sender of the text message or to a third party, through a communication network. In the figures referred to below, and particularly in FIGS. 1 through 8, similar reference characters denote corresponding features for the sake of clarity and consistency.

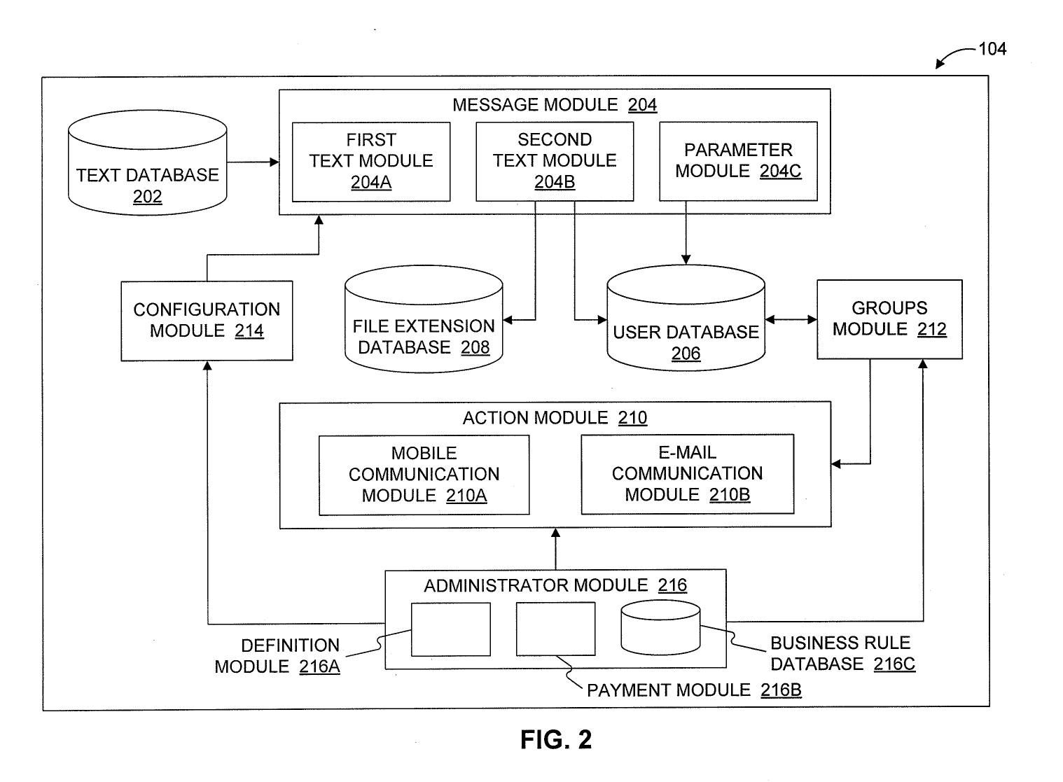

FIG. 1 illustrates a system view of a mobile device 102 communicating with a platform server 104 through a network 106, according to an embodiment of the invention. The mobile device 102 (e.g., a GSM phone, a UMTS phone, a CDMA phone, a CDMA 2000 phone, a PDC, a TDMA phone, a PDA (Pocket Digital Assistant), a touch sensitive device, a handheld device, or a wireless device) may send a text message to a short code number, to a mobile number, directly to the platform server, or indirectly to the platform server. The platform server 104 may receive information such as the text message, store the text message (e.g., in the message database 202 of FIG. 2), process the text message depending upon the information in the received text message, and perform certain actions (e.g., through the action module 210 of FIG. 2).

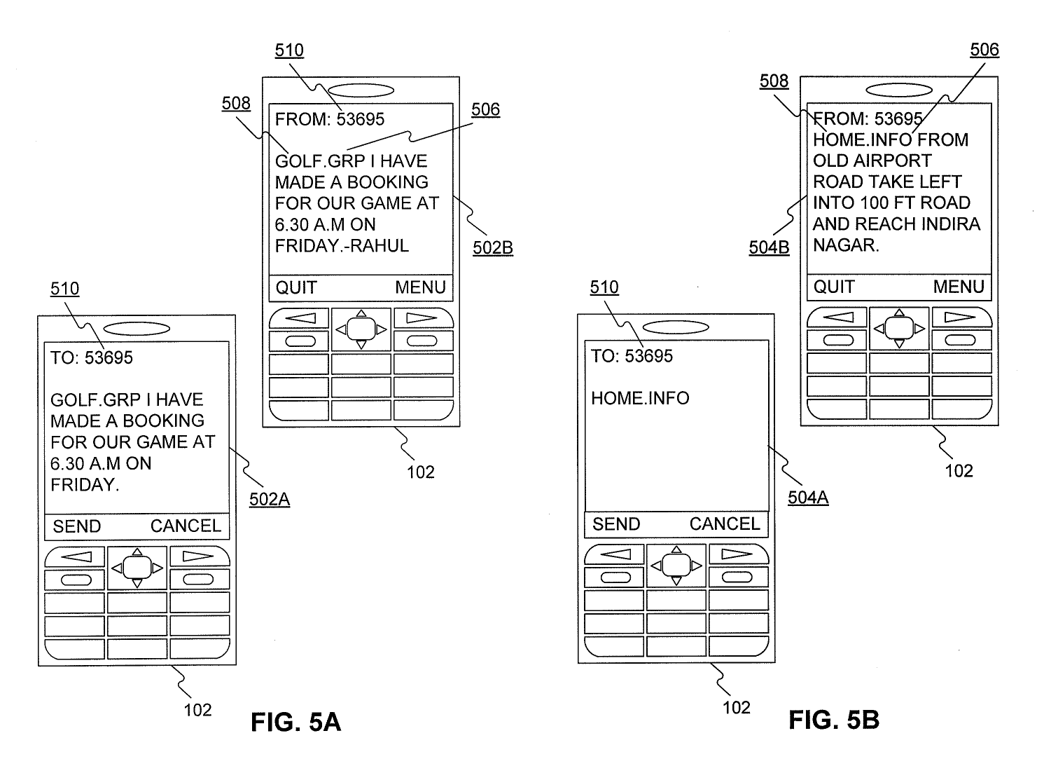

The text message may have a first text element (e.g., the first text element 506 of FIG. 5A) and a second text element (e.g., the second text element 508 of FIG. 5A) separated by a non-alphanumeric visible character such as a dot, a hash, or an asterisk. In addition, the text message may have a parameter such as a <message>, containing information that may be used by a platform server. In one embodiment, if the text message includes the expression “abc.grp <message>”, the platform server 104 initiates a message <message> to all contacts associated with a particular group (e.g., abc.grp). The non-alphanumeric visible character along with the second text element 508 may be pre-configured at the platform server 104 (e.g., by the configuration module 214 of FIG. 2) and interpreted to invoke a pre-assigned function (e.g., through the action module 210 of FIG. 2).

The network 106 may include Short Message Service Center (SMSC), protocols (e.g., HTTP and SMPP) and a gateway. The SMSC handles the SMS operations of a wireless network. In one embodiment, when a user sends a text message from the mobile device 102, it will first reach an SMSC. The SMSC may then forward the SMS message to the platform server 104. In another embodiment, the text message may need to pass through more than one network entity (e.g. an SMSC and an SMS gateway) before reaching the platform server 104. A short message peer-to-peer protocol (SMPP) exchanges the SMS text messages between SMS entities such as SMSCs.

FIG. 2 illustrates an exploded view of the platform server 104 of FIG. 1. According to some embodiments of the invention, the platform server 104 has an message database 202, a message module 204, a file extension database 208, a user database 206, an action module 210, a groups module 212, a configuration module 214, and an administrator module 216. The message module 204 includes a first text module 204A, a second text module 204B and a parameter module 204C. The action module 210 includes a mobile communication module 210A and an email communication module 210B. The message database 202 contains text messages (e.g., simple text messages having the first text element 506 and the second text element 508 linked by a visible non-alphanumeric character such as a dot, a hash and an asterisk) obtained from senders.

According to various embodiments, a text message obtained from a sender is automatically stored in the message database 202. The first text module 204A may extract the first text element 506 from the message database 202 and interpret the first text element 506 of the text message. The second text module 204B may extract the second text element 508 (e.g., an extension associated with the message) from the message database 202 and check if the extension in the second text element 508 matches any of the extensions stored in the file extension database 208. In one embodiment where the text message comprises the expression ‘abc.DOC abc@xyz.com’, the first text element is the name of a user, the second text element (DOC) is a file extension, and a file with the ‘DOC’ extension is present in the file extension database 208. In another embodiment, where the text message comprises the expression ‘personAlileA.DOC abc@xyz.com’, the first text element is interpreted to be a user of the system, and the second text element is interpreted as being the file “fileA.DOC” associated with the user, personA.

In another embodiment involving the expression ‘Kgs.CARD’, the second text element is ‘CARD’ and the corresponding requisite business card information is stored in the user database 206 and not in the file extension database 208. The parameter module 204C may obtain the message stored in the message database 202 and check whether the text message comprises an email address or a simple text message. In one embodiment involving the expression, ‘abc.DOC <abc@xyz.com>’, the text message includes the e-mail address, ‘abc@xyz.com’. In another embodiment involving the expression ‘Kgs.CARD’, the text message has only the card name to be sent to a mobile number. The user database 206 may contain mobile numbers, email addresses and business card information associated with users. The file extension database 208 may contain information on the files associated with the sender of the text message (e.g., .doc, .xls).

According to some other embodiments, a message involving an expression of the form ‘firstelement.partofsecondelement!’ may result in the second element being identified as a partially-specified element due to the use of a special, predefined symbol such as ‘!’. The platform server 104 may then have to accurately identify the partially defined second element. For example, upon receiving the text message ‘companyA.Human!’ the server may search all of the sub-categories associated with predefined category companyA that begin with or contain the term ‘Human.’ Such a search may lead the server to accurately identify the subcategory ‘Human Resources’ associated with the category ‘companyA.’

In many embodiments, the mobile communication module 210A sends information (e.g., a text message, business card information) to a single number or multiple contacts associated with a group. In one embodiment, where the text message involves the expression ‘abc.GRP <message>’, a message is sent to the contacts associated with the group ‘GRP’ stored in the user database 206. In another embodiment involving the expression ‘Kgs.CARD,’ business card information stored in the user database 206 is sent to the mobile device 102 by the mobile communication module 210A. The e-mail communication module 210B may send information (e.g., text message, files with extensions such as .doc and .xls) to an e-mail address. For example, if a text message involves the expression ‘abc.DOC abc@xyz.com’, a file from the file extension database is e-mailed to the address ‘abc@xyz.com’ by the email communication module 210B. Additionally, the groups module 212 may add and update contacts associated with an existing group, and delete contacts associated with an existing group.

According to various embodiments, the configuration module 214 provides a medium for editing an action associated with a category. The administrator module 216 includes a definition module 216A, a payment module 216B, and a business rule database 216C. The definition module 216A enables an administrator to predefine the first text element 506 (e.g., grp). The payment module 216B detects an action performed by the action module 210. For example, when a user performs an action (e.g., sending a text message) to communicate with a group or a member of the group through the platform server 104, the payment module 216B determines how much to charge for the particular action. The business rule database 216C contains information related to transactions/payments associated with actions (e.g., a 50 cent charge for a group message or a 1 dollar charge for an email).

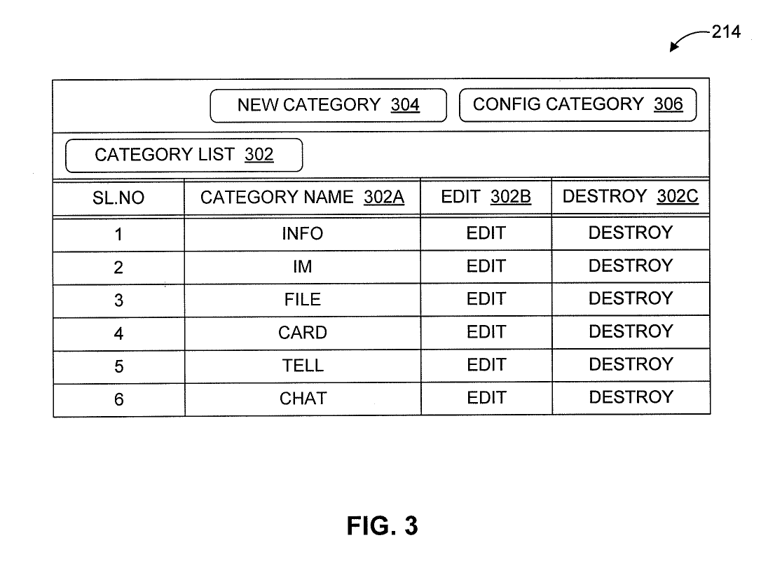

FIG. 3 is a user interface view of the configuration module 214 of the platform server 104 of FIG. 1. According to some embodiments, the configuration module 214 has a category list 302, a new category 304, and a configure category 306. The category list 302 includes a category name 302A field, an edit option 302B and a destroy option 302C. The category name 302A field includes extensions info, im, file, card, tell, and chat. In one embodiment, where the text message is ‘abc.info <message>’, the extension ‘info’ is the category name associated with some information. In another embodiment, where the text message is ‘Kgs.CARD <message>’, the extension ‘.CARD’ refers to business card information. The edit option 302B is used to edit a category name 302A in the category list 302. The destroy option 302C is used to destroy or delete a category name 302A in the category list 302. The new category option 304 may be used to add a new category to the existing category list 302. The configure category option 306 may be used to configure a category name 302A in the category list 302.

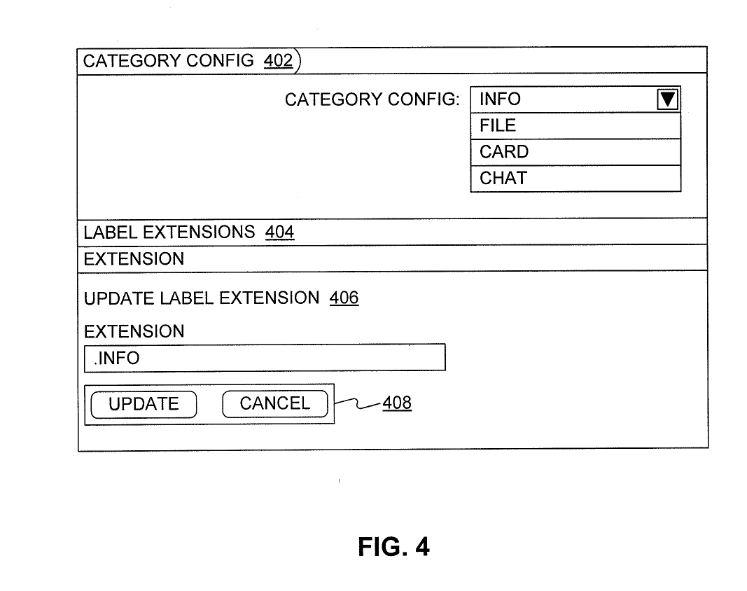

FIG. 4 is a depiction of a category configuration user interface of configuration module 214 of platform server 104 of FIG. 1. The interface has a configure category option 402, label extensions field 404, update label extensions field 406, options 408. The select category option 402 may enable the administrator to select a category name (e.g., .info, .file, .card, and .chat) from a category list using, for example, a pull down or drop down menu. The extension field 404 may enable the administrator to add an extension name (e.g., the extension ‘.info’ may be entered in the extension field 404). The options 408 include an update option to update a category name (e.g., .info) and a cancel option to cancel the category name.

FIG. 5A and FIG. 5B provide user interface views of mobile device 102 of FIG. 1. They depict the mobile device 102 communicating text messages to a third party 502 and an individual user 504. According to various embodiments, the text messages may have a first text element 506, a second text element 508, and a short code number 510. The first text element 506 may be predefined by an administrator and the second text element 508 may be preconfigured by a user. The short code number 510 may be a target number. In one embodiment, user Rahul has created a text message that includes the expression ‘GOLF.GRP’ as well as a parameter (e.g., the message, “I have made a booking for our game at 6.30 A.M on Friday”). This results in a group message 502A being sent to the platform server 104 of FIG. 1.

In another embodiment, ‘GRP’ is the first text element 506, and represents a category that is predefined by an administrator. ‘GOLF’ is the second text element 508, and represents members of a group that is preconfigured by the user, Rahul. The platform server 104 sends the group message 502B (e.g., “Golf.grp I have made a booking for our game at 6.30 A.M on Friday—Rahul”) to a third party. The third party may be the golf group or a member of the golf group. In another embodiment, a sender requests information by sending the text message ‘Home.info’, without any parameters, to the short code number 510. The associated information is preconfigured by the user and stored in platform server 104 under ‘home.info’. This results in the associated information (e.g., “From old airport Road take left into 100 ft road and reach Indira nagar”) being sent back to the text message sender's mobile device 102.

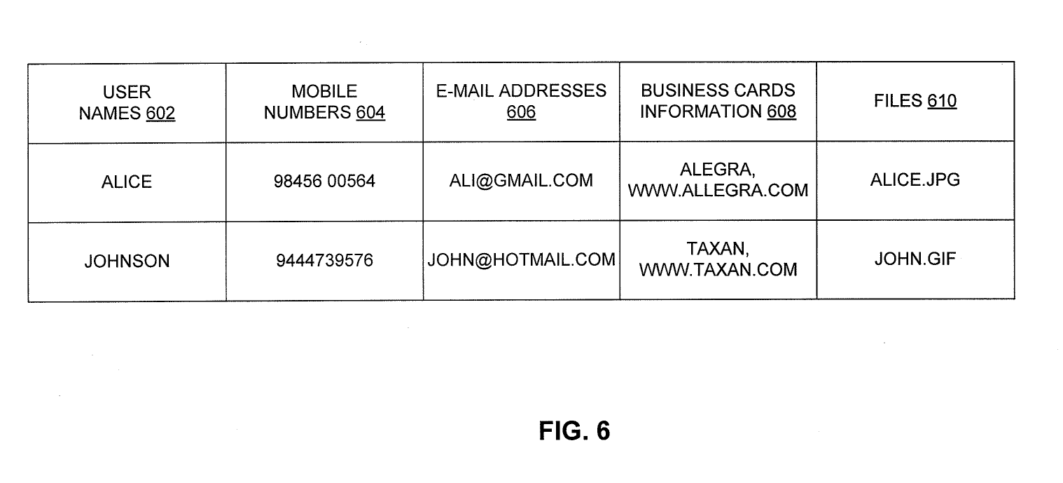

FIG. 6 illustrates a table view of user database 206 associated with platform server 104 of FIG. 1. User database 206, according to some embodiments, has a users names 602 field, a mobile numbers 604 field, an email addresses 606 field, a business card information 608 field, and a files field 610. The users names 602 field includes system users' names (e.g., Alice and Johnson). The users may be senders of text messages and/or members of a group. The mobile numbers 604 field includes the mobile numbers of the users (e.g., 9845600564 is the mobile number of user Alice, and 9444739576 is the mobile number of user Johnson).

The email addresses 606 field includes the email addresses of the users (e.g., ali@gmail.com and john@hotmail.com). The business card information 608 field includes information such as names, company information and contact information (e.g., street addresses and website addresses) of users. The files 610 field includes files (e.g., Alice.jpg and John.gif) associated with users.

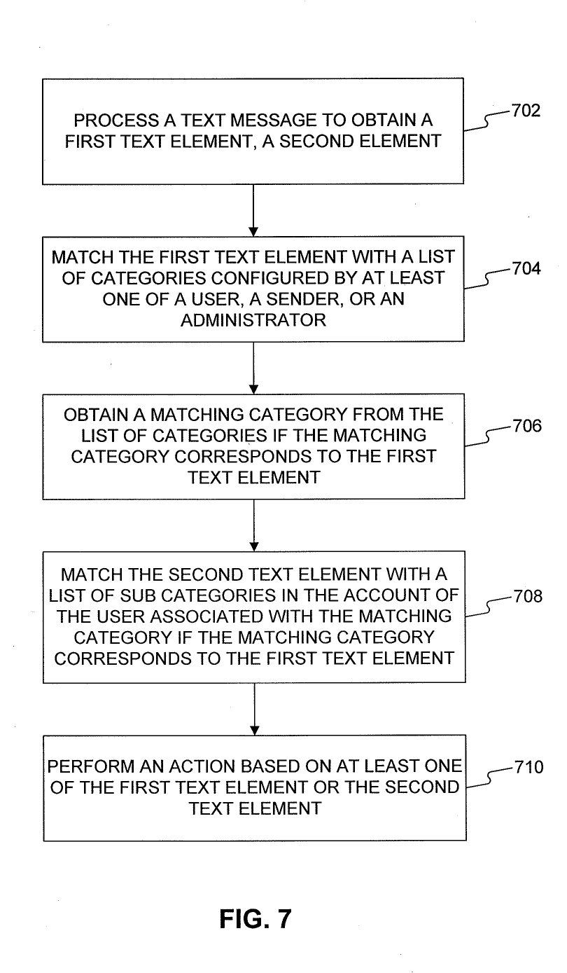

FIG. 7 is a flow diagram illustrating a method of processing a text message according to some embodiments of the invention. The text message is first sent to the platform server 104 of FIG. 1 through a target number. In step 702, the text message is processed to obtain a first text element 506, a second text element 508 and a parameter. In one embodiment, the parameter may be a null parameter. For example, the first text element 506 may be “GRP”, and the second text element may be “GOLF” (e.g., as shown in FIG. 5A and FIG. 5B). In step 704, the first text element 506 is matched with a list of categories configured by at least one of a user, a sender, or an administrator (e.g., as shown in FIG. 3). In step 706, a matching category (e.g., GRP) is obtained from the list of categories, where the matching category corresponds to the first text element 506.

In step 708, the second text element is matched against a list of sub categories associated with the account of a user that is associated with the obtained matching category. In step 710, an action is performed based on at least one of the first text element 506 and the second text element 508. The parameter obtained in step 702 may be, for example, information such as a greeting, or identifying information such as an email address. In some embodiments, the action of step 710 may include communicating the parameter to one or more contacts associated with the first text element 506 (e.g., as shown in FIG. 5A), if the first text element 506 corresponds to a predefined category defined in the list of categories. In other embodiments, the action of step 710 may include communicating a file (preconfigured in user database 206 of the platform server 104 of FIG. 1) to the email address associated with the account of a user, or to a mobile number (e.g., as shown in FIG. 5B).

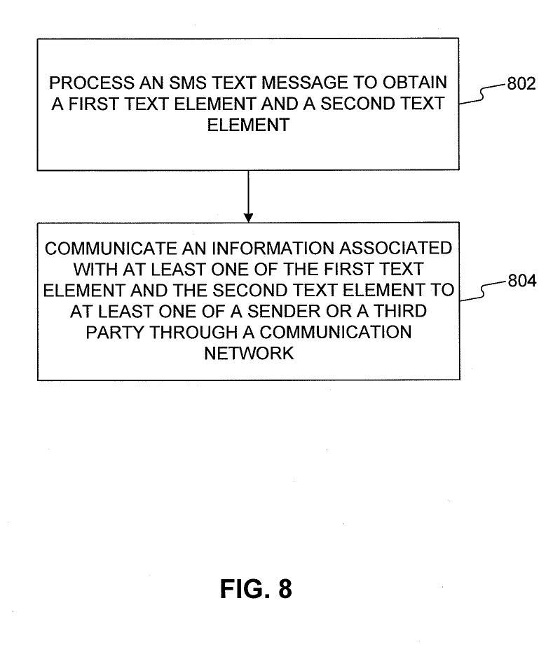

FIG. 8 is a flow diagram illustrating a method of processing a text message to obtain a first text element 506 and a second text element 508, according to some embodiments. In step 802, the text message is processed to obtain the first text element and the second text element. In many embodiments, the text message is processed at platform server 104 of FIG. 1. The text message may be sent to the platform server 104 through a target number (e.g., short code number 510 of FIG. 5A). The platform server 104 is administered by at least one of an administrator, and a user with an account associated with platform server 104.

In another embodiment, the first text element 506 and the second text element 508 are linked by a visible non-alphanumeric character (e.g., as shown in FIG. 5A and FIG. 5B). In step 804, information associated with at least one of the first text element and the second text element is communicated (e.g., using the action module 210) to at least one of the sender of the text message or a third party, through a communication network (e.g., network 106 of FIG. 1). In some embodiments the sender may be a user who sends the text message to the platform server 104, and the third party may be a group or a member of a group.

The techniques provided by the various embodiments of the present invention may be implemented on an integrated circuit chip (not shown). The embodiments described herein may take the form of hardware, software or a combination of hardware and software. The embodiments that are implemented in software include but are not limited to, firmware, resident software, and microcode.

Furthermore, the embodiments described herein may take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

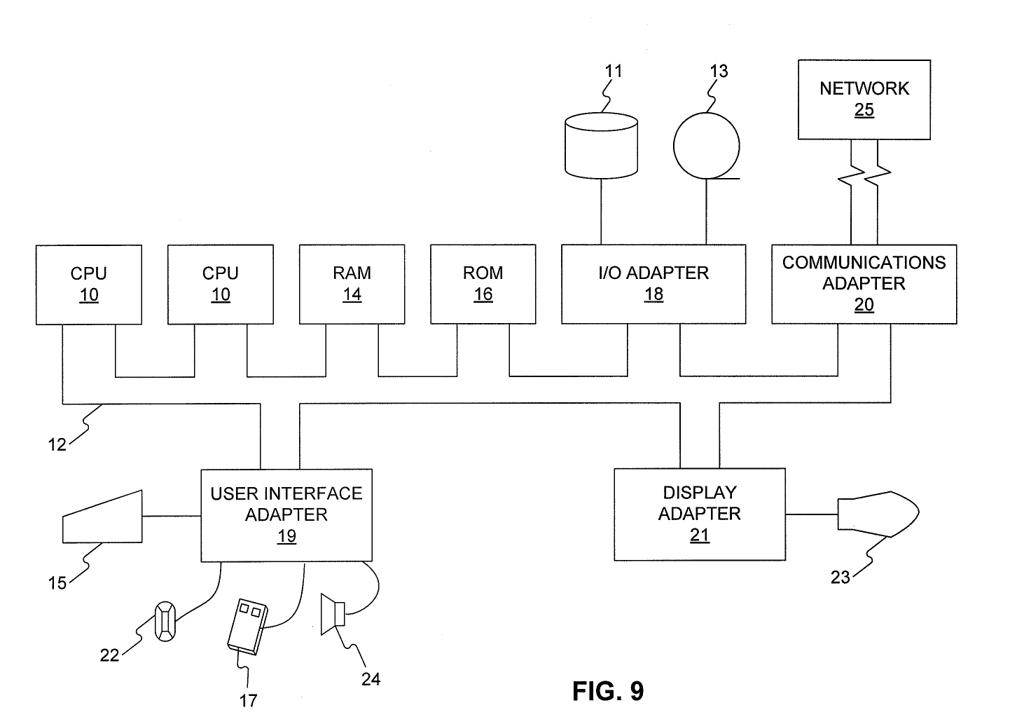

A representative hardware environment for practicing the embodiments described herein is depicted in FIG. 9. The drawing illustrates a system that comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system may read instructions on the program storage devices and follow these instructions to execute the methodology of the embodiments described herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter.

The embodiments described herein provide an efficient and powerful method of enhancing the transfer of data in a communication network from a single mobile device 102 of FIG. 1 to multiple contacts in a community or a group by using key words separated by a non-alphanumeric character (e.g., a dot and an asterisk) to enhance usability.

The foregoing description of the various embodiments reveal the general nature of the invention in order that others may, by applying current knowledge, readily modify and/or adapt the various embodiments for various applications, without departing from the spirit and scope of the invention. Therefore, such adaptations and modifications are intended to be within the meaning and range of equivalents of the disclosed embodiments. It is to be understood that the phraseology or terminology employed herein is for the purpose of description and should not be construed as limiting. Therefore, those skilled in the art will recognize that the embodiments described herein can be practiced with modification within the spirit and scope of the appended claims.

What is claimed is:

1. A method of processing a text message at a platform server, the text message being sent by a sender to the platform server, the platform server being administered by at least one of an administrator, and a user with or without an account associated with the platform server, the text message comprising a first text element and a second text element linked by a visible non-alphanumeric character, the method comprising:
processing the text message to obtain the first text element and the second text element; and
communicating information associated with at least one of the first text element and the second text element to at least one of the sender and a third party, through a communication network;
wherein the first text element is associated with the user of the platform server, and the second text element is pre-specified by at least one of a user of the platform server, and an administrator of the platform server.

2. The method of claim 1, wherein the non-alphanumeric character comprises one of a dot, a hash, and an asterisk.

3. The method of claim 1, further comprising obtaining a mobile number associated with the sender of the text message.

4. The method of claim 1, wherein the second text element corresponds to a group of contacts, the first text element is an identifier of the group of contacts, the third party is associated with the group of contacts, and the communication network is a mobile network.

5. The method of claim 1, wherein the text message further comprises an additional parameter associated with contact information or message information.

6. The method of claim 1, wherein the second text element is an extension associated with a file, the first text element is a file name, and the target number is a short code number.

7. The method of claim 1, further comprising determining that the second text element is incomplete, and identifying one or more sub-categories associated with the first text element to facilitate the accurate identification of a completed form of the second text element.

8. The method of claim 7, wherein the accurate identification of the completed form of the second text element is achieved through interaction with the sender of the text message.

9. A system administered by at least one of an administrator and a user with or without an account associated with the system, the system comprising:
a memory for storing information associated with a text message; and
a processor for processing the text message sent by a sender to the system through a target number, the text message comprising a first text element and a second text element linked by a visible non-alphanumeric character, the processor being configured to:
process the text message to obtain the first text element and the second text element;
match the first text element against a list of categories configured by at least one of the user, the sender, and the administrator;
obtain a matching category from the list of categories if the matching category corresponds to the first text element;
match the second text element with a list of sub categories in the account of a user associated with the matching category; and
perform an action based on at least one of the first text element and the second text element.

10. The system of claim 9, wherein the processor is further configured to determine that the second text element is incomplete, and identify one or more sub-categories associated with the first text element to facilitate the accurate identification of a completed form of the second text element.

11. The system of claim 10, wherein the accurate identification of the completed faun of the second text element is achieved through interaction with the sender of the text message.

12. The system of claim 9, wherein the text message further comprises a parameter.

13. The system of claim 12, wherein the action involves communicating the parameter to contacts associated with the first text element, if the first text element corresponds to a predefined category associated with the list of categories.

14. The system of claim 12, wherein the parameter is an email address, and the action involves communicating a file to the email address.

15. A computer-readable storage medium comprising programmable instructions adapted to be executed on one or more processors, and to perform a method of processing a text message at a platform server, the text message being sent by a sender to the platform server through a target number, the platform server being administered by at least one of an administrator, and a user with or without an account associated with the platform server, the text message comprising a first text element and a second text element linked by a visible non-alphanumeric character, the method comprising:
processing the text message to obtain the first text element and the second text element; and
communicating information associated with at least one of the first text element and the second text element to at least one of the sender and a third party, through a communication network,
wherein the first text element is associated with the user of the platform server, and the second text element is pre-specified by at least one of a user of the platform server, and an administrator of the platform server.

16. The computer-readable storage medium of claim 15, wherein the non-alphanumeric character comprises one of a dot, a hash, and an asterisk.

17. The computer-readable storage medium of claim 15, further comprising obtaining a mobile number associated with the sender of the text message.

18. The computer-readable storage medium of claim 15, wherein the second text element corresponds to a group of contacts, the first text element is an identifier of the group of contacts, the third party is associated with the group of contacts, and the communication network is a mobile network.

19. The computer-readable storage medium of claim 15, wherein the text message further comprises an additional parameter associated with contact information or message information.

20. The computer-readable storage medium of claim 15, wherein the second text element is an extension associated with a file, the first text element is a file name, and the target number is a short code number.
